(19) United States
(12) Patent Application Publication
(10) Pub. No.: US 2008/0008347 A1
(43) Pub. Date: Jan. 10, 2008

(54) Acoustic Transducer

(76) Inventors: Claus-Peter Hinke, Burgdorf (DE); Axel Grell, Burgdorf (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 11/628,331

(22) PCT Filed: Jun. 3, 2005
(86) PCT No.: PCT/EP05/05972

§ 371 Date: May 10, 2007

(30) Foreign Application Priority Data
Jun. 3, 2004 (DE) 10 2004 027 111.9

(51) Int. Cl. H04R 1/32

(52) U.S. Cl. 381/429

(57) ABSTRACT

There is provided an acoustic transducer having a capsule housing and a damping element of plastic film which has holes produced by a laser.

### CROSS-REFERENCE TO RELATED APPLICATIONS

This application claims priority of International Application No. PCT/EP2005/005972, filed Jun. 3, 2005 and German Application No. 10 2004 027 111.9, filed Jun. 3, 2004, the complete disclosures of which are hereby incorporated by reference.

### BACKGROUND OF THE INVENTION

a) Field of the Invention

The present invention concerns an acoustic transducer.

b) Description of the Related Art

In the case of acoustic transducers, the directional characteristic thereof can be adjusted inter alia by means of a damping element. Damping elements of that kind have hitherto been produced from damping silks, for example from a woven fabric. Fabrics however suffer from the disadvantage that great deviations can occur within the fabric areas of between about 10 and 50%. In addition fabrics are difficult to handle so that automation of the processing procedure is often not possible so that the processing of acoustic transducers of that kind has to effected manually.

Furthermore, a high degree of dispersion in respect of the damping values within a damping silk means that manual adjustment of the damping action is required for each acoustic transducer, if the situation involves high-grade microphones.

DE 35 21 845 A1 discloses an electrodynamic loudspeaker. DE 28 51 745 A1 discloses a diaphragm for an electro-acoustic transducer.

DE 29 37 926 A1 discloses a diaphragm for electro-acoustic transducers, wherein electro-acoustic components are arranged in a frame housing. The diaphragm of the electro-acoustic transducer has a first and a second outer layer with a core of honeycomb form, wherein that honeycomb core is arranged in a sandwich structure between the first and second outer layers. A thin damping layer is arranged between the outer layer and the core.

DE 198 31 771 A1 discloses a plastic encapsulation for an acoustic transducer. The housing of the capsule is injection molded from plastic material, wherein the plastic material is injected on to or around the damping element when the capsule is injection molded.

### OBJECT AND SUMMARY OF THE INVENTION

Accordingly the primary object of the invention is to improve the production of acoustic transducers in such a way that adjustment of the directional characteristic is made possible, in an automatic processing procedure.

That object is attained by an acoustic transducer in accordance with the invention comprising a capsule housing and a clamping element of plastic film which has holes produced by a laser.

Accordingly there is provided an acoustic transducer comprising a capsule housing and a damping element of plastic film.

The degree of dispersion of the damping values within the damping element can be substantially reduced by the plastic film of a substantially constant thickness. In addition, a plastic film is substantially easier to handle than damping silk, in the assembly procedure.

In accordance with an aspect of the present invention the plastic film represents a polyimide film. Polyimide has proven to be advantageous as it has a high level of internal damping, that is to say no harmonics are radiated from the film.

In accordance with a further aspect of the present invention the plastic film has a predetermined number of holes at predetermined positions, thereby suitably adjusting the damping of the damping element.

In accordance with a further aspect of the present invention the holes are produced in the plastic film by a laser. Precise bores or holes can be produced in the plastic film by means of the laser.

In accordance with a further aspect of the present invention the plastic film is welded on the capsule housing by means of a hot sealing punch.

In accordance with a further aspect of the present invention the plastic film is fused to the capsule housing by means of solvent.

In accordance with a further aspect of the present invention the plastic film is glued on the capsule housing by a double-sided adhesive strip. That represents a clean and tidy solution, in particular for manual assembly.

In accordance with a further aspect of the present invention the plastic film is clamped in the capsule housing.

The invention is described in greater detail with reference to the drawing.

### BRIEF DESCRIPTION OF THE DRAWING

FIG. 1 shows a plan view of a damping element according to the invention.

### DESCRIPTION OF THE PREFERRED EMBODIMENTS

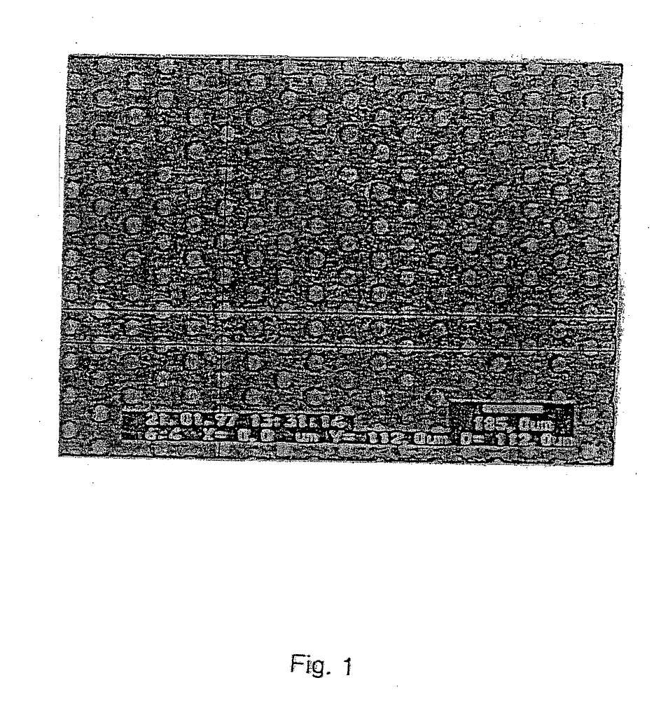

A plastic film as shown in FIG. 1 is used instead of a damping silk for adjusting the damping of an acoustic transducer such as for example a microphone, a loudspeaker or a headset capsule. The plastic film can be produced in or of the correspondingly desired geometry. For that purpose, holes are provided only at the locations of the film, which are actually required. Formation of the desired holes or damping elements can be effected for example by an excimer laser or by a water jet. The use of a laser however is advantageous as the desired damping elements or holes can be formed in the plastic film precisely and quickly.

For example a polyimide film such as Kapton is suitable as a plastic film, as that material has a high level of internal damping, which is desirable for avoiding harmonics in the film. A further advantage of polyimide films is that they have good stiffness, which makes itself noticeable in positive terms, in particular when assembling the plastic film. In addition plastic films with good stiffness can be also better processed in an automated assembly procedure, and that contributes to a reduction in costs.

Various procedures are possible for fitting the film to a capsule housing. The film can be welded on to the capsule housing by a hot stamping punch. As an alternative thereto, the film can be fused to the plastic housing of the capsule housing, using a solvent. A further form of procedure for fitting the film to the capsule housing is represented by the use of a double-sided adhesive strip with which the film can be glued on the housing. That is advantageous in particular for manual assembly as it represents a clean and tidy solution. A further alternative for fitting the film to the capsule housing involves clamping the film in or on the housing.

The frequency response of the acoustic transducer can be influenced by a precise selection of the geometry of the holes in the film and by the precise bores thereof, in particular by means of a laser. In that respect in particular a loudness effect can be achieved in the case of headset capsules with a suitable plastic film and different acoustic pressures.

While the foregoing description and drawings represent the present invention, it will be obvious to those skilled in the art that various changes may be made therein without departing from the true spirit and scope of the present invention.

What is claimed is:

1-7. (canceled)

8. An acoustic transducer comprising:
a capsule housing; and
a damping element of plastic film which has holes produced by a laser.

9. The acoustic transducer as set forth in claim 8, wherein the plastic film represents polyimide film.

10. The acoustic transducer as set forth in claim 8, wherein the plastic film has holes for adjusting the damping of the acoustic transducer.

11. The acoustic transducer as set forth in claim 8, wherein the plastic film is welded to the capsule housing by means of a hot stamping punch.

12. The acoustic transducer as set forth in claim 8, wherein the plastic film is fused to the capsule housing by means of a solvent.

13. The acoustic transducer as set forth in claim 8, wherein the plastic film is glued on the capsule housing.

14. The acoustic transducer as set forth in claim 8, wherein the plastic film is clamped in or on the capsule housing.
